(19) United States
(12) Patent Application Publication
(10) Pub. No.: US 2004/0001194 A1
(43) Pub. Date: Jan. 1, 2004

(54) Electromagnetic and optical analyzer

(75) Inventors: Jan Brian Wilstrup, Mounds View, MN (US); Peng Li, Fremont, CA (US)

Correspondence Address: MERCHANT & GOULD PC, P.O. BOX 2903, MINNEAPOLIS, MN, 55402-0903, US

(73) Assignee: Wavecrest Corporation, Edina, MN

(21) Appl. No.: 10/278,039

(22) Filed: Oct. 21, 2002

Related U.S. Application Data
(63) Continuation of application No. 09/630,380, filed on Aug. 1, 2000, now abandoned.

(51) Int. Cl. G01N 21/00

(52) U.S. Cl. 356/73.1

(57) ABSTRACT

A method and apparatus for measuring characteristics in an electromagnetic or optical system. A modulation signal is provided to a device under test to provide a first signal and to a reference device which provides a second signal, and a tine domain optical analyzer measures the transitions of the first signal and the transitions of the second signal to determine characteristics of the device under test. In one embodiment, the characteristics of the reference device are determined with a modulated light source having two or more known wavelengths that provides a first signal, and a second signal is provided to a reference device to create a third signal. A time domain optical analyzer measures the transitions of the first signal and the transitions of the third signal for two or more wavelengths to determine reference device signal delay time characteristics as a function of wavelength.

### TECHNICAL FIELD

This invention relates in general to measurement apparatus; system and method for analyzing an electromagnetic and optical sy

### BACKGROUND OF THE INVENTION

Today's infrastructure growth in fiber communication systems is largely driven by data transfer increases over the internet. It is estimated that the peak data rate at a node of a public network in North America already reaches ˜1 Tb/s (terabit/second) and the internet traffic is increasing at a rate of over 200% per year. Given these overwhelming data rate demands, copper based transmission media will not be able to satisfy this need at a reasonable cost. Further, even if optical fiber offers much better bandwidth (e.g., ˜5 Th/s over 1540-1565 nm window), it will not be able to keep pace with the demanding curve unless more fibers are installed.

For a point-to-point based communication system, two ways to increase the data rate are: 1) increase the data rate for the single channel point-to-point link (e.g., OC48 to OC192); 2) add more point-to-point link based channels over the same fiber (dense wavelength division multiplexing (DWDM)). In practice, the optimal approach may be to use both 1) and 2).

Although ˜5 Tb/s data rate is a theoretical expectation for an optical fiber carrier at the window of 1540-1565 nm (nanometer), it is limited to less than 100 Gb/s (gigabit/second) in practice due to the fiber dispersion and switching speed of the transmitter and receiver. Dispersion is a change in signal delay as a function of wavelength. Recent development of Erbium doped fiber amplifier (EDFA) now provides for a fiber transmission distance of more than 300 km without any regeneration in between, reducing the power attenuation limitation significantly. Dispersion is common to both single channel point-to-point link and multi-channel DWDM and is one of the most important limiting factors for a fiber communication system. Recent developments of dispersion compensators ease the dispersion problem but do not eliminate it. However, good measurements of dispersion for a fiber are keys when designing a good dispersion compensator. Crosstalk is DWDM specific and it is caused by the interference from other channels.

DWDM systems typically have hundreds of channels, each one running at a rate of ˜10 Gb/s or higher. To accommodate the high number of channels, channel spacing of <50 GHz is needed. Dispersion limits higher data rate and crosstalk constrains smaller channel spacing. Good methods and apparatus for measuring and characterizing these and other limiting factors are critical keys to the design and manufacture of good and reliable DWDM systems. Dispersion, crosstalk, jitter, and their interrelationship should be considered.

Dispersion is used to describe how a light wave speed changes with wavelength within a fiber. Dispersion can be caused by many different mechanisms. For a single mode fiber, dispersion mechanisms can be either chromatic, or polarization induced. Chromatic dispersion is material related. For a fiber silica, the optical refractive index is a function of wavelength, therefore light with different wavelengths travel at different speeds. Polarization dispersion is caused by the variations of fiber core geometry along its length. The geometrical variation leads to the “birefringence,” that is: orthogonally-polarized components which have different refractive indexes/propagation speeds. The two orthogonally-polarized modes are generally coupled in a random manner. It is generally characterized by the rms value of a Gaussian distribution.

Crosstalk is the interference between simultaneously propagating signals. Crosstalk causes power transfer/amplitude fluctuation between channels. There are basically two types of crosstalk, one is linear and another is nonlinear: Linear crosstalk is composed of: 1) out-of-band crosstalk, which is typically associated with the optical filters and demultiplexer; 2) in-band crosstalk that is associated with wavelength router. Nonlinear crosstalk is caused by stimulated Raman scattering (SRS), stimulated Brillouin scattering (SBS), and four-wave mixing. Nonlinear SRS and SBS are examples where the fiber itself acts as an amplifier for longer wavelength when the differences between longer wavelengths and short wavelengths fall within a certain range. The probability for a SRS to occur is much higher than that for a SBS since the gain bandwidth for SRS is ˜5 THz, while the gain bandwidth for SBS is ˜0.05 GHz. When a DWDM system has more than three channels, a fourth wave mixing (FWM) will occur at a frequency equal to the superposition of the original three. For a DWDM system with many channels, there are many FWM possibilities. DWDM can cause both in-band and out-of-band crosstalk.

A communication system is used to carry information. For a digital optical communication system, it means that coding/decoding bit streams of zeros (0s) and ones (1s) is needed. Jitter is used to quantify any displacement in time or amplitude relative to an ideal. Bit error rate (BER) is used to quantify the overall performance for a communication system or component. Jitter is a statistical process and has a probability density function (PDF) associated with it. PDF can be approximated by normalizing the histogram over the total measurement sample. Jitter has two major components, one is deterministic (DJ), and another is random (RJ), each having its own PDF. Jitter may be viewed as a signal that can be described in time-domain, frequency-domain, or wavelength-domain. Jitter limits the bit rate and degrades the performance of any communication system. As discussed above, there are many different physical mechanisms to cause dispersion and crosstalk. Dispersion and crosstalk can cause jitter and in turn cause BER to increase. Jitter may cause a logical 1 to be detected when a logical 0 is expected or vice-versa. BER relates to a jitter PDF through an integration process. Small jitter and BER are important requirements for analyzing and designing communication systems and their components.

The optical spectrum analyzer (OSA) is a commonly used wavelength-domain measurement instrument. A typical OSA combines a high-speed optical detector and a wavelength filter. The wavelength filter scans the wavelength range of the interest and measures the amplitude/power at a given wavelength. The optical power as a function of wavelength is obtained and displayed. Key performance parameters for an OSA are spectral resolution, sensitivity, and dynamic range. The major limitations of an OSA are: 1.) no phase information; 2.) no time-domain information. Only the average spectrum information is measured. Further, an OSA does not measure the transient characteristics of the wavelength. Transient information is valuable in analyzing communications systems because the transient state is often an accurate description of the state of the system; 3) analysis speed is limited by electromechanical components; 4) significant spurious responses in the form of side-lobes due to the limitations of the optical filters. Because of these limitations, an OSA is generally not suitable for measuring fiber dispersion. Finally, while an OSA is used to give an estimate of adjacent channel crosstalk, it will not provide crosstalk information for non-adjacent channels.

A bit error rate tester (BERT) is used to measure the bit error rate (BER) by moving the bit clock edge around the data edges. It requires both a bit clock and a data signal to conduct the measurement. An O-to-E converter is needed in order to measure the BER for an optical system/component.

Known methods of dispersion measuring are electromechanical based. For example, light is passed through two arms of a Mach-Zender interferometer and the light intensity is measured across the spectrum with a photoelectric device. The mechanical irregularities of such a system cause spurious responses.

### SUMMARY OF THE INVENTION

In accordance with the present invention, the above and other problems are solved by providing method and apparatus for measuring characteristics in an electromagnetic or optical system. One embodiment provides a modulated light source having two or more known wavelengths, a splitter, coupled to the modulated light source, providing a first and second signal, a system under test coupled to the first signal to generate a third signal, and a time domain optical analyzer for measuring the transition of the second signal and the transition of the third signal for two or more wavelengths to determine system under test signal delay time characteristics as a function of wavelength.

Another embodiment provides a modulated light source having unknown wavelength characteristics, a splitter, coupled to the modulated light source, having a first signal and a second signal, a reference system having known time delay characteristics as a function of wavelength coupled to the first signal to generate a third signal, and a time domain optical analyzer for measuring delay between the transition of the second signal and the transition of the third signal to determine system characteristics.

The modulation signal may be provided for diagnostic functions including use in comparing the transitions of the first, second, or third signals to the transitions of the modulation signal to determine jitter characteristics of various system components.

In yet another embodiment, the time delay characteristics of the reference system are determined with a system including a modulated light source having two or more known wavelengths, a splitter, coupled to the modulated light source, providing a first signal and a second signal coupled to a system under test to generate a test signal, and a time domain optical analyzer for measuring delay between the transition of the first signal and the transition of the test signal for two or more wavelengths to determine reference system time characteristics.

A significant advantage of the invention is that it provides a method and apparatus for analyzing electrical and optical components and systems. System characteristics such as jitter, dispersion, spectrum, and crosstalk may be analyzed.

These and various other features as well as advantages, which characterize the present invention, will be apparent from a reading of the following detailed description and a review of the associated drawings.

### BRIEF DESCRIPTION OF THE DRAWINGS

FIG. 1a illustrates a typical fiber optical system/component testing setup;

FIG. 1b illustrates another typical fiber optical system/component testing setup;

FIG. 2a illustrates one embodiment of a fiber optical system/component testing setup according to the present invention;

FIG. 2b illustrates another embodiment of a fiber optical system/component testing setup according to the present invention;

FIG. 3 illustrates an exemplary hardware environment for an optical analyzer according an embodiment of the present invention;

FIG. 4 illustrates a system for DWDM characterization and testing;

FIG. 5 illustrates a typical DWDM system; and

FIGS. 6A-6C illustrate exemplary matrices according to one embodiment of the present invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

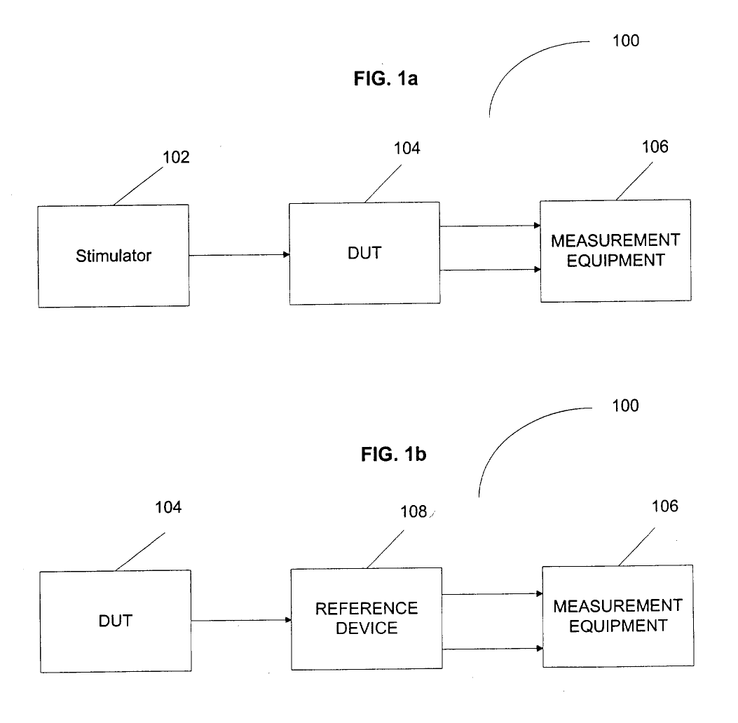

FIG. 1a illustrates a fiber optical system/component testing setup 100 according to one embodiment of the present invention, including a stimulator 102 (e.g., Tunable Laser source (TLS) which has a known wavelength), a device under test (DUT) 104 (e.g., fiber, filter, and other passive devices alone or in combination with active devices such as an amplifier) and a time domain measurement equipment 106. An exemplary time domain measurement equipment 106 is the Wavecrest DTS-2077, available from Wavecrest Corporation, Edina, Minn., which may be adapted to accept optical signals through the use of optical to electrical converters (O/E converter). The DTS-2077 is comparator based, but other time interval measurement systems may be used, such as the oscilloscope. Another time domain measurement equipment is a time interval analyzer (available from Agilent Technologies, Inc., Palo Alto, Calif.). The stimulator 102 of the setup 100 is typically common to various DUTs 104 and measurement instruments 106.

FIG. 1b illustrates another typical fiber optical system/component testing setup 100, including a device under test (DUT) 104 (which can be any light source such as a stimulator, semiconductor laser, LED, or gas laser), a reference device 108 (e.g., fiber, filter, and other passive devices alone or in combination with active devices such as an amplifier), and a response measurement equipment 106. The reference device 108 has known dispersion characteristics such that the dispersion characteristics of the DUT 102 can be determined. Those skilled in the art will recognize that other hardware arrangements may be used to test the optical system components.

Time-domain measurement equipment 106 may include an optical sampling oscilloscope (OSO). An OSO is composed of a sampling oscilloscope and an optical-to-electrical (O/E) converter in the front end. An OSO is trigger based and it samples the input signal waveform. An OSO measures only the light intensity at particular times and it does not alone provide the components of the dispersion or the spectrum of the signal.

The optical analyzer (Wavecrest DTS-2077) is a comparator based instrument and it measures the edge transition corresponded time at a programmed amplitude level. It is composed of a time signal analyzer plus an O/E converter. Unlike the OSO, the optical analyzer measures rising edge and falling edge jitter, as well as channel-to-channel jitter with much better measurement speed than other devices. With the channel-to-channel jitter measurement capability, an optical analyzer can be used to measure dispersion induced jitter and dispersion function.

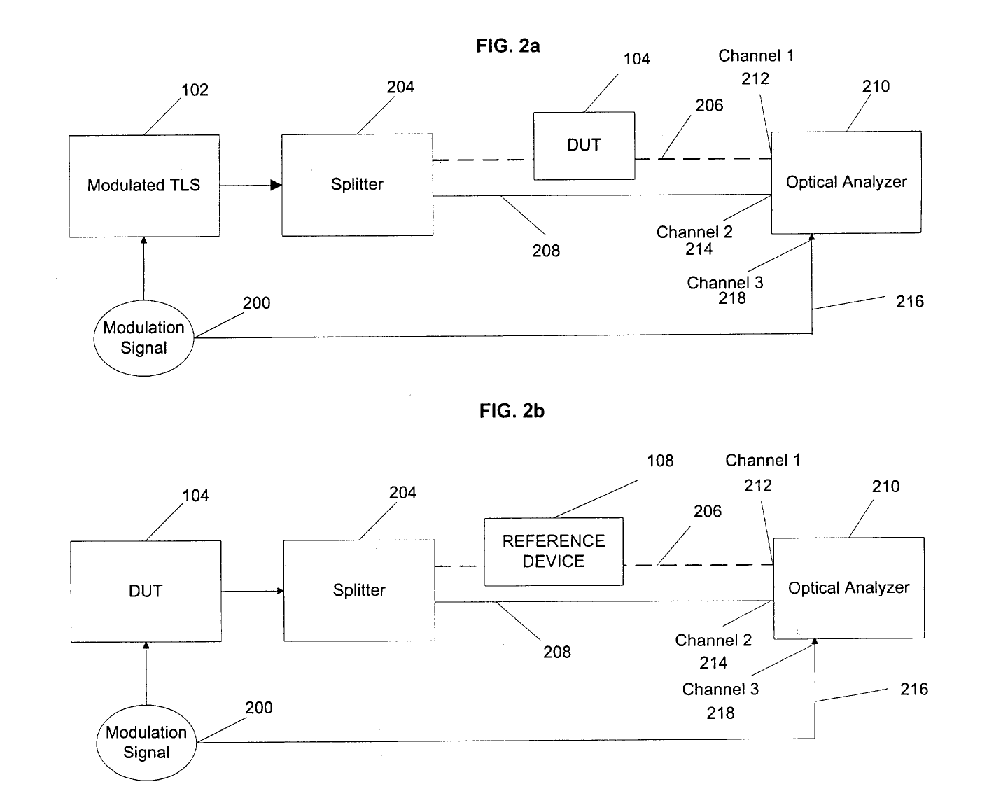

FIG. 2a illustrates one embodiment of a fiber optical system/component testing setup 100 according to the present invention. An electrical modulation signal 200 is provided to a modulated tunable laser source 102 (Model No. HP81680A available from Agilent Technologies, Inc., Palo Alto, Calif. and optical modulator (EOM) (Model No. HP8164A available from Agilent Technologies, Inc., Palo Alto, Calif.)). The modulated tunable laser source 102 provides a signal to a splitter 204 attached to a device under test 104. Device under test 104 is typically a fiber optic cable, filter, or other passive devices alone or in combination with active devices such as an amplifier, whose dispersion characteristics need measurement. Device under test 104 provides a first signal 206 to a first channel input 212 of the optical analyzer 210 and a third signal 208 from the splitter 204 is attached to the second channel input 214 of the optical analyzer 210.

The electrical modulation signal 200 provides a modulation signal 216 to a third channel input 218 which may be an electrical channel input of the optical analyzer 210. This modulation signal 216 may provide a variety of diagnostic information. For example, the modulation signal 216 may be used for fault isolation, such as determining whether a modulation signal is being generated. The modulation signal 216 may also be used to measure the jitter characteristics of the modulation signal 200 prior to any jitter added by the other system components. The modulation signal 216 may also be used as a reference source to isolate jitter or other system characteristics that are not common between channel one 212 and channel two 214 of the optical analyzer 210. For example, the jitter due to the modulation signal 200 and the modulated TLS 102 are eliminated with a channel one 212 and channel two 214 measurement. In contrast, measurements between modulation signal 216 and first signal 206 or third signal 208 allow measurements of the jitter associated with the modulation signal 200 or the modulated TLS 102. The transitions of each of the signals 206, 206, and 216 may be compared to themselves to determine diagnostic information, including whether the signal is active and the jitter associated with the signal.

FIG. 2a demonstrates a system whereby the signal delay of the DUT 104 as a function of wavelength is determined. The light source provided by the TLS 102 can be modulated through a range of wavelengths and the signal delay is measured through the device under test 104. The delay is measured by comparing the transitions of the signals under measurement. Although one transition of a signal may be measured, better results are obtained by taking multiple measurements. These transitions may be the rising edge or the falling edge of the signal. Multiple measurements may be taken and the mean may be calculated for multiple time periods. These measurements may be normalized to create a dispersion curve. For example, if DUT 104 is a fiber, the measurements are converted to picoseconds per nanometer per kilometer ps/(nm*km). The physical length of the fiber will need to determined to scale this measurement. Alternatively, the system of FIG. 2a may be configured to determine system characteristics such as jitter that do not require a direct measurement of the signal wavelength. For example, the jitter associated with the DUT 104 may be measured through a comparison of first signal 206 and third signal 208.

FIG. 2b illustrates another embodiment of a fiber optical system/component testing setup 100 according to the present invention. An electrical modulation signal 200 provides a signal to a DUT 104 having unknown characteristics. DUT 104 may be a multimode communications laser, LED, or other modulatable light source. The DUT 104 provides a signal to a splitter 204 attached to a reference device 108 and optical analyzer 210. Reference device 108 is typically a fiber optic cable, filter, and other passive devices alone or in combination with active devices such as an amplifier, having known signal delay characteristics as a function of wavelength. For example, these may be dispersion characteristics. Reference device 108 provides a first signal 206 to a first channel input 212 of the optical analyzer 210 and a third signal 208 from the splitter 204 is attached to the second channel input 214 of the optical analyzer 210. Those skilled in the art will recognize that other hardware arrangements are possible such that the characteristics of an unknown device may be determined. Wavelength characteristics of the unknown device may include spectrum, jitter, drift, unit to unit variations, power supply variations, temperature, time, and chirp. The optical analyzer 210 takes a statistical sample of the spectrum through the range of wavelengths. If the dispersion characteristic of reference device 108 is a one to one function, a spurious free spectrum is measured. Alternatively, measurements may be taken such that DUT 104 characteristics that may not be measured as a function of wavelength, such as jitter, may be determined.

The electrical modulation signal 200 provides a modulation signal 216 to a third channel input 218 which may be an electrical channel input of the optical analyzer 210. This modulation signal 216 may provide a variety of diagnostic information. For example, the modulation signal 216 may be used for fault isolation, such as determining whether a modulation signal is being generated. The modulation signal 216 may also be used to measure the jitter characteristics of the modulation signal 200 prior to any jitter added by the other system components. The modulation signal 216 may also be used as a reference source to isolate jitter or other system characteristics that are not common between channel one 212 and channel two 214 of the optical analyzer 210. For example, the jitter due to the modulation signal 200 and the modulated TLS 102 are eliminated with a channel one 212 and channel two 214 measurement. In contrast, measurements between modulation signal 216 and first signal 206 or third signal 208 allow measurements of the jitter associated with the modulation signal 200 or the modulated TLS 102. The transitions of each of the signals 206, 206, and 216 may be compared to themselves to determine diagnostic information, including whether the signal is active and the jitter associated with the signal.

The known dispersion characteristics of reference device 108 may be determined through the use of the system illustrated in FIG. 2a. Similarly, other known characteristics of the reference device 108 (including wavelength characteristics or time domain characteristics such as jitter that may be measured independent of wavelength) may be determined. For example, DUT 104 may be a fiber with unknown characteristics. Once the dispersion characteristics of the fiber are determined as illustrated in FIG. 2a, this fiber may serve as the reference device 108 as illustrated in FIG. 2b. From there, the characteristics of DUT 104 (a multimode laser, for example) may be determined.

The optical analyzer 210 analyzes the deterministic and random components of a distribution. Jitter in serial data communication is a difference of data transition times relative to ideal bit clock active transition times. As in all signals, jitter has deterministic and random components. Deterministic jitter is bounded in its amplitude and can be measured as a peak to peak value. Random jitter is unbounded in its amplitude and Gaussian in nature. Since random jitter is probabalistic, it may be quantified by one sigma of standard deviation estimate. Random jitter is modeled by a Gaussian distribution. The total jitter distribution may be modeled by the superposition of multiple Gaussian functions. The optical analyzer 210 may separate the deterministic and random components of the jitter. A PDF for the deterministic component and rms value for the random component can be obtained. Additional information regarding methods of determining jitter are disclosed in co-pending application Ser. Nos. 09/240,742 and 09/240,742, assigned to Wavecrest Corporation, which are hereby incorporated by reference.

As the TLS 102 sweeps through the wavelength range of the interest, the deterministic jitter PDF and random jitter rms value as a function wavelength are measured. Since jitter is caused by dispersion and the jitter PDF has certain unique features, therefore, jitter as function of wavelength can be used to infer the dispersion as a function of wavelength for the DUT 104.

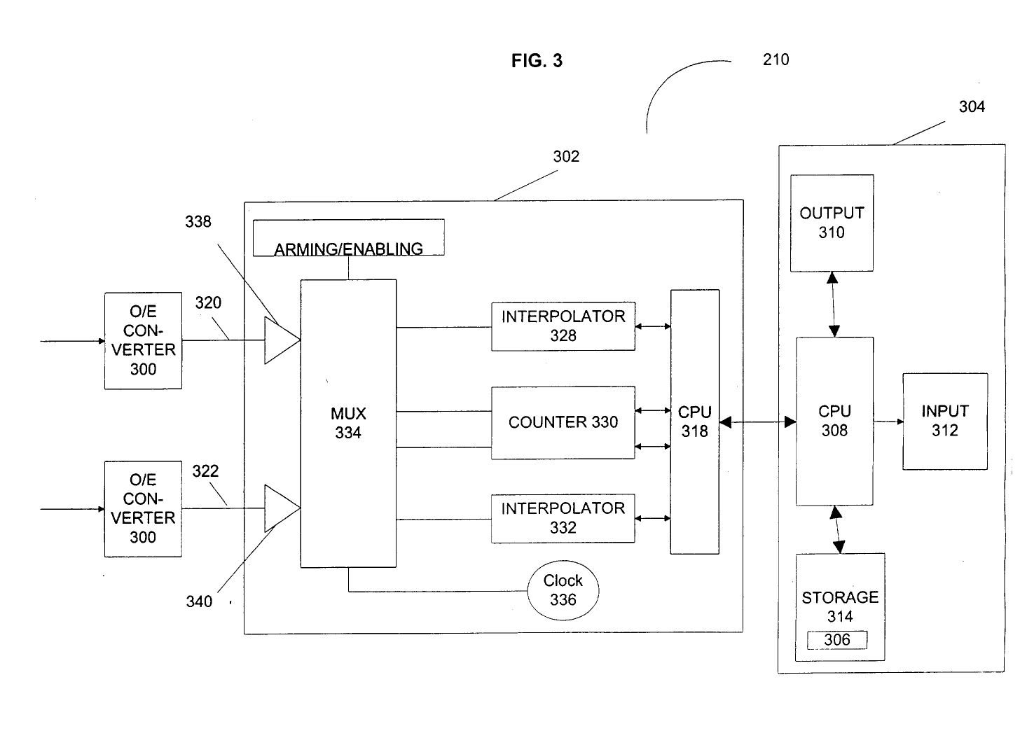

FIG. 3 is an exemplary illustration of a representative hardware environment for optical analyzer 210 according an embodiment of the present invention. A typical configuration may include a measurement apparatus 302 that measures the time interval between two events (start and stop) through counters. A measurement apparatus is disclosed in U.S. Pat. No. 4,908,784, which is hereby incorporated by reference. A typical measurement apparatus is the Wavecrest DTS-2077, available from Wavecrest Corporation, Edina, Minn.

The measurement apparatus 302 interfaces to a workstation 304 and operates under the control of an analysis program 306 resident on the workstation 304. The analysis program 306 is typically implemented through data analysis software. One commercially available analysis software is the Wavecrest Virtual Instrument (VI) software, available from Wavecrest Corporation, Edina, Minn. Other analysis software includes LABVIEW, MathCad, MATLAB, Mathematica, among others. The workstation 304 comprises a processor 308 and a memory including random access memory (RAM), read only memory (ROM), and/or other components. The workstation 304 operates under control of an operating system, such as the Linux, UNIX® or the Microsoft® Windows NT operating system, stored in the memory to present data to the user on the output device 310 and to accept and process commands from the user via input device 312, such as a keyboard or mouse.

The analysis program 306 of the optical analyzer 210 is preferably implemented using one or more computer programs or applications executed by the workstation 304. Those skilled in the art will recognize that the functionality of the workstation 304 may be implemented in alternate hardware arrangements, including a configuration where the measurement apparatus 302 includes CPU 318, memory 340, and I/O 338 capable of implementing some or all of the steps performed by the analysis program 306. Generally, the operating system and the computer programs implementing the present invention are tangibly embodied in a computer-readable medium, e.g. one or more data storage devices 314, such as a zip drive, floppy disc drive, hard drive, CD-ROM drive, firmware, or tape drive. However, such programs may also reside on a remote server, personal computer, or other computer device.

The analysis program 306 provides for different measurement/analysis options and measurement sequences. The analysis program 306 interacts with the measurement apparatus 302 through the on-board CPU 318. The measurement apparatus 302 provides arming/enabling functionality such that the apparatus 302 can measure a signal either synchronously or asynchronously. Multiple optical signals (206, 208, or 216 for example) are provided to O/E converters 300 which convert the optical signal to an electrical signal. Alternatively, O/E converters 300 may be adapted to receive a multichannel signal and operate in combination with a demultiplexer to separate the channels. The signal from the O/E converters 300 is fed to the channel input arming/enabling controls 320 and 322 to which event that a measurement of a transition is made. Comparators 338 and 340 compare the signal applied to controls 320 and 322 to an internal reference voltage. Counter/interpolators 328, 330, and 332 measure the time elapsed between the start and stop events. Interpolators provide fine time resolution down to 0.8 ps. In response to input controls 320 and 322, multiplexer 334 controls the counter/interpolators 328, 330, and 332 based on a clock 336 signal. Clock 336 is typically a precise crystal oscillator.

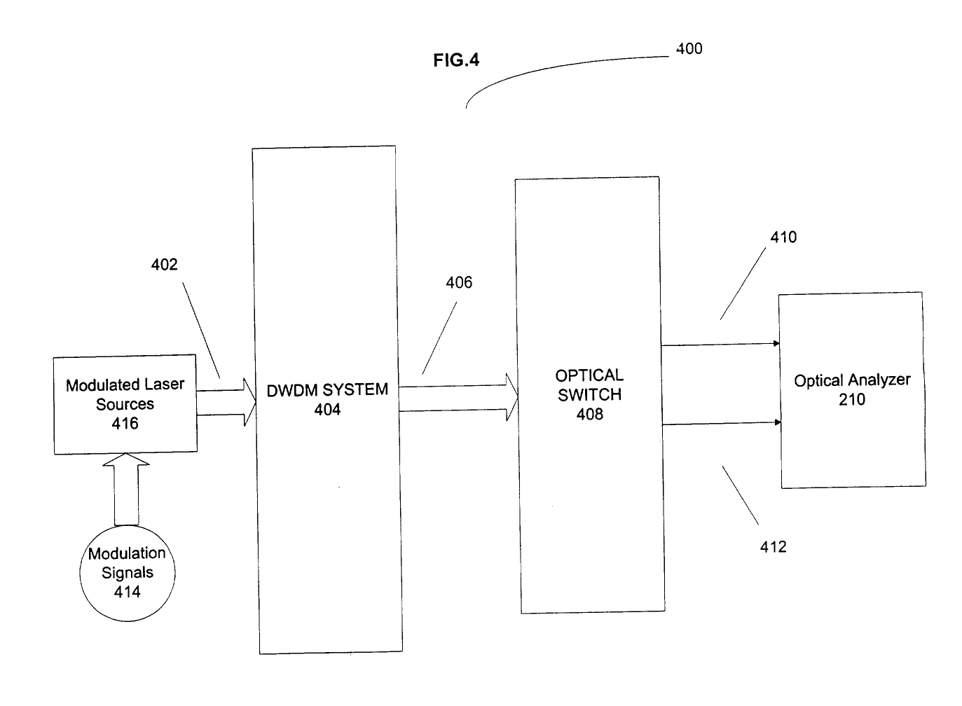

FIG. 4 illustrates a system 400 for DWDM characterization and testing according to one embodiment of the present invention. In the embodiment of FIG. 4, the optical analyzer 210 provides channel-to-channel and channel to itself jitter measurement capability. The electrical modulation signal 414 provides signals to modulated laser sources 416 which generates signals on fiber 402. The signals on fiber 402 are provided to a DWDM system 404 which has N channels 406 with wavelengths λ₁-λ_{N}. In one embodiment, an optical switch 408 selects two channels 410 and 412 from the channels 406. Alternatively, optical switch 408 could be replaced by a bank of O/E converters and an electrical switch. In yet another embodiment, optical analyzer 210 may be adapted to receive a DWDM signal from the DWDM system 404, demultiplex the signal, and convert it to an electrical signal.

In the embodiment of FIG. 4, signal 410 is connected to a first channel input of the optical analyzer 210 and signal 412 is attached to the second channel input of the optical analyzer 210. In another embodiment, the optical analyzer 210 has inputs for more than two channels. The optical switch 408 would provide a multichannel output accordingly. In testing the components of the DWDM 404, based on known reference information, the characteristics of unknown components or systems may be determined. These characteristics may include channel frequency or wavelength leakage, stimulated Raman scattering, stimulated Brillouin scattering, four-wave mixing, signal degradation of a light source, light source chirp, dispersion compensating drift, and temperature drift.

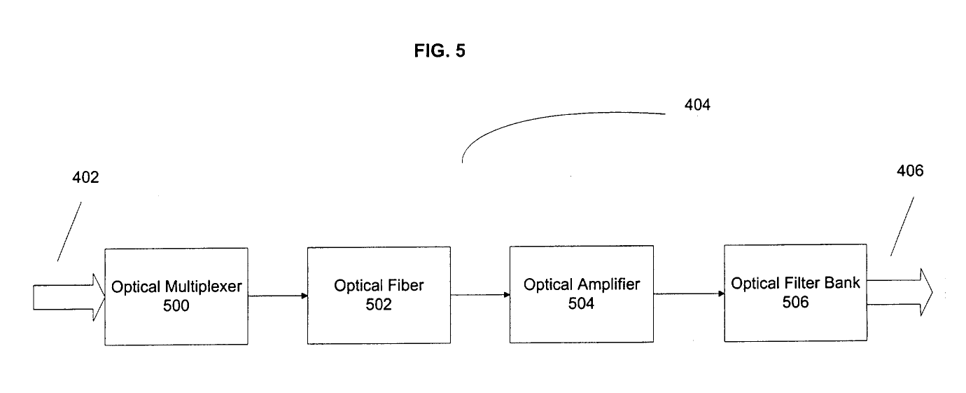

The DWDM system 404 may typically include a multiplexer, fiber medium, a demultiplexer, and other components. FIG. 5 is block diagram illustrating a typical DWDM system 404. Signals on fiber 402 are provided to an optical multiplexer 500, an optical fiber 502, an optical amplifier 504, and an optical filter bank 506. Optical filter bank 506 provides the channels 406 to the optical switch 408. DWDM 404 may include other components, including a dispersion compensator, optical isolator, optical pumps, optical splitter, and/or optical switch.

Those skilled in the art will recognize that the testing system of FIG. 4 may be configured to analyze frequency domain multiplexing systems. Thus, the system 400 may be adapted to test components of a wireless system having multiple frequency channels, for example.

The transitions between two or more of the channels of the DWDM system may be determined. The transitions of a channel are compared to each other and they may be compared to one or more of the other channels. Although one transition may be measured, better results are obtained through multiple measurements. In one embodiment, the optical analyzer 210 under the control of analysis program 306 provides DWDM jitter crosstalk matrixes (NxN, one for DJ PDF peak-to-peak and another for RJ rms). The jitter PDF between a channel i and a channel j is measured. The DJⱼ matrix and the RJrmsⱼ matrix are formed. The analysis program 306 generates these matrices by channel to other channel and channel to itself measurements. There may be systematic or random interrelationships between the matrix elements. The matrices may record the jitter measurements (either DJ or RJ) quantitatively or qualitatively. The matrix has symmetrical properties along the diagonal. Those two matrixes give instant overall diagnostics of a DWDM system 400. The diagonal of the matrices provide a channel to itself reference. The matrices provide information to measure characteristics of the laser source or the demulitplexer, for example, in the DWDM 400 system. The matrices may be used to measure crosstalk, eliminate one of more bad sources or channels, determine a bad filter for the demultiplexer function, determine a dead channel or marginal channel, determine a bad modulation signal, or determine wavelength drift of a dispersion compensator. Once such a faulty component is determined, the optical analyzer 210 may institute a corrective action. Corrective actions may include an instruction to shut down a bad channel, route a bad channel to another channel, or send an operator notification regarding the faulty component. For example, a DWDM system 400 may have a broad laser channel with unacceptable jitter. When the crosstalk matrices are analyzed, the bad channel may be automatically shut down.

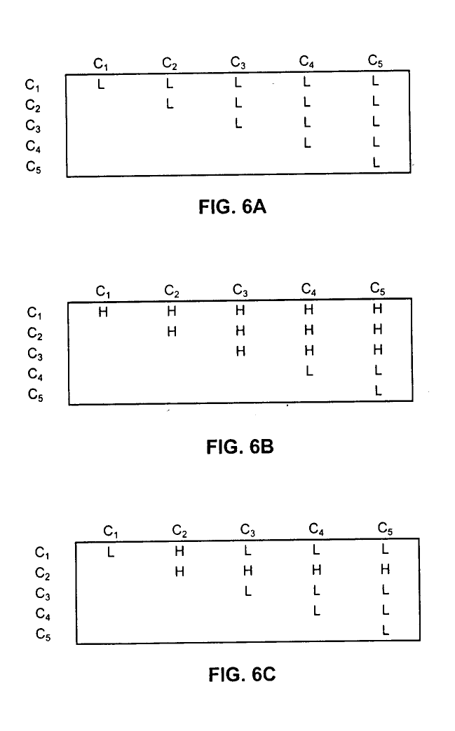

FIGS. 6A-6C illustrate exemplary matrices according to one embodiment of the present invention. FIGS. 6A-6C illustrate a system having five channels C₁-C₅. In this example, the jitter magnitudes are recorded qualitatively, as either high (H) or low (L). The jitter matrix may record DJ or RJ. FIG. 6A illustrates a baseline jitter matrix having low jitter. FIG. 6B illustrates a system where the C₂ source spectrum is too wide. As illustrated in FIG. 6B, the wide spectrum of C₂ causes cross-talk to channels C₁ and C₃. FIG. 6C illustrates a system whereby a demux filter C₂ has drifted high causing crosstalk from channel C₃ to channel C₂. The optical analyzer 210 may shut down channel C₂. Different characteristics of the DWDM system 400 will have different patterns in the matrix. The differences will be most noticeable when comparing good systems and systems having one or more problems.

This jitter crosstalk matrix may be converted to an amplitude (power) crosstalk matrix if the data bit period and amplitude are known. Similarly, if the fiber 402 dispersion characteristics are known, the spectrum of the modulated laser sources 416 may be determined for the rising and falling edges respectively.

While the invention has been particularly shown and described with reference to preferred embodiments thereof, it will be understood by those skilled in the art that various other changes in the form and details may be made therein without departing form the spirit and scope of the invention.

What is claimed is:

1. A method for measuring characteristics in an optical system under test comprising the steps of:
receiving a modulated source signal having two or more known wavelengths;
splitting the signal into a first and second signal;
providing the second signal to the system under test to generate a third signal; and
measuring delay between a transition of the first signal and a transition of the third signal for two or more wavelengths to determine system under test signal delay time characteristics as a function of wavelength.

2. The method of claim 1, wherein the measuring step comprises the steps of:
measuring delay between a transition of the first signal and a transition of the third signal for multiple time periods for each wavelength of the two or more wavelengths; and
calculating the mean of the multiple time periods.

3. The method of claim 1, further comprising the step of: measuring jitter between the first signal and the third signal.

4. The method of claim 1, further comprising the steps of:
receiving a modulation signal; and
measuring delay between a transition of the first signal and a transition of the modulation signal for two or more wavelengths to determine system under test signal delay time characteristics as a function of wavelength.

5. The method of claim 1, further comprising the steps of:
receiving a modulation signal; and
measuring delay between a transition of the third signal and a transition of the modulation signal for two or more wavelengths to determine system under test signal delay time characteristics as a function of wavelength.

6. The method of claim 1, further comprising the step of measuring delay between transitcions of the first signal.

7. The method of claim 1, further comprising the step of measuring delay between transitions of the third signal.

8. The method of claim 4, further comprising the step of measuring delay between transitions of the modulation signal.

9. The method of claim 1, wherein the signal delay time characteristics describe signal dispersion.

10. The method of claim 1, wherein the measuring step comprises the step of measuring delay between transitions of the first signal and transitions of the third signal relative to a threshold voltage.

11. An apparatus for measuring characteristics in an optical system under test, comprising:
a modulated light source having two or more known wavelengths;
a splitter, coupled to the modulated light source, having a first output and a second output providing a second signal;
the system under test coupled to the first output signal to generate a third signal; and
a time domain optical analyzer for measuring a transition of the third signal and a transition of the second signal for two or more wavelengths to determine system under test signal delay time characteristics as a function of wavelength.

12. The apparatus of claim 11, wherein the time domain optical analyzer measures delay between a transition of the first signal and a transition of the third signal for multiple time periods for each wavelength of the two or more wavelengths and calculates the mean of the multiple time periods.

13. The apparatus of claim 11, wherein the time domain optical analyzer measures jitter between the first signal and the third signal.

14. The apparatus of claim 11, further comprising a modulation signal, wherein the optical analyzer measures delay between a transition of the first signal and a transition of the modulation signal for two or more wavelengths to determine system under test signal delay time characteristics as a function of wavelength.

15. The apparatus of claim 11, further comprising a modulation signal, wherein the optical analyzer measures delay between a transition of the third signal and a transition of the modulation signal for two or more wavelengths to determine system under test signal delay time characteristics as a function of wavelength.

16. The apparatus of claim 11, wherein the optical analyzer measures delay between transitions of the first signal.

17. The apparatus of claim 11, wherein the optical analyzer measures delay between transitions of the third signal.

18. The apparatus of claim 14, wherein the optical analyzer measures delay between transitions of the modulation signal.

19. The apparatus of claim 11, wherein the signal delay time characteristics describe signal dispersion.

20. The apparatus of claim 11, wherein the time domain optical analyzer comprises voltage comparators which receive the third signal and the second signal.

21. A method for measuring characteristics in an optical system, comprising the steps of:
receiving a modulated source signal having unknown wavelength characteristics from a source under test;
splitting the signal into a first and second signal;
providing the second signal to a reference system having known time delay characteristics as a function of wavelength to generate a third signal; and
measuring delay between a transition of the first signal and a transition of the third signal to determine system characteristics.

22. The method of claim 21 wherein the system characteristics comprise source under test wavelength characteristics.

23. The method of claim 21 wherein the system characteristics comprise reference system time jitter characteristics.

24. The method of claim 21 wherein the system characteristics comprise source under test jitter characteristics.

25. The method of claim 21, further comprising the step of measuring jitter between the first signal and the third signal.

26. The method of claim 21, further comprising the steps of:
receiving a modulation signal; and
measuring delay between a transition of the first signal and a transition of the modulation signal to determine system characteristics

27. The method of claim 21, further comprising the steps of:
receiving a modulation signal; and
measuring delay between a transition of the third signal and a transition of the modulation signal to determine system characteristics.

28. The method of claim 21, further comprising the step of measuring delay between the transitions of the first signal.

29. The method of claim 21, further comprising the step of measuring delay between transitions of the third signal.

30. The method of claim 27, further comprising the step of measuring delay between the transitions of the modulation signal.

31. The method of claim 22, wherein the wavelength characteristics are selected from a group comprising spectrum, jitter, drift, unit to unit variations, power supply variations, temperature, time, and chirp.

32. The method of claim 22, wherein the measuring step comprises the step of comparing the transition of the first signal and the transition of the third signal relative to a threshold voltage.

33. The method of claim 21, wherein the reference system known time delay characteristics are measured through the steps of:
receiving a modulated source signal having two or more known wavelengths;
splitting the signal into a first source and second source signal;
providing the second source signal to a system under test to generate a system under test signal; and
measuring delay between a transition of the first source signal and a transition of the system under test signal for two or more wavelengths to determine reference system characteristics.

34. The method of claim 21, wherein the reference system known time delay characteristics are measured through the steps of:
receiving a modulated source signal having two or more known wavelengths;
splitting the signal into a first source and second source signal;
providing the second source signal to a system under test to generate a system under test signal; and
measuring delay between a transition of the first source signal and a transition of the system under test signal for two or more wavelengths to determine reference system delay time characteristics as a function of wavelength.

35. The method of claim 22, wherein the reference system known time delay characteristics are measured through the steps of:
receiving a modulated source signal having two or more known wavelengths;
splitting the signal into a first source and second source signal;
providing the second source signal to a system under test to generate a system under test signal; and
measuring delay between a transition of the first source signal and a transition of the system under test signal for two or more wavelengths to determine reference system jitter characteristics.

36. The method of claim 35, wherein the system delay time characteristics describe signal dispersion.

37. The method of claim 34, wherein the measuring step comprises the step of measuring delay between the transitions of the first signal and the transitions of the third signal relative to a threshold voltage.

38. The method of claim 21, wherein the reference system known time delay characteristics are measured through the steps of:
receiving a modulated source signal having two or more known wavelengths;
receiving a modulation signal;
splitting the signal into a first source and second source signal;
providing the second source signal to a system under test to generate a system under test signal; and
measuring delay between transitions of the modulation signal and transitions of the system under test signal for two or more wavelengths to determine reference system characteristics.

39. The method of claim 22, wherein the reference system known time delay characteristics are measured through the steps of:
receiving a modulated source signal having two or more known wavelengths;
receiving a modulation signal;
splitting the signal into a first source and second source signal;
providing the second source signal to a system under test to generate a system under test signal; and
measuring delay between transitions of the modulation signal and transitions of the system under test signal for two or more wavelengths to determine reference system delay time characteristics as a function of wavelength.

40. The method of claim 23, wherein the reference system known time delay characteristics are measured through the steps of:
receiving a modulated source signal having two or more known wavelengths;
receiving a modulation signal;
splitting the signal into a first source and second source signal;
providing the second source signal to a system under test to generate a system under test signal; and
measuring delay between transitions of the modulation signal and transitions of the system under test signal for two or more wavelengths to determine reference system jitter characteristics.

41. The method of claim 39, wherein the system delay time characteristics describe signal dispersion.

42. The method of claim 38, wherein the measuring step comprises the step of measuring delay between the transitions of the first signal and the transitions of the third signal relative to a threshold voltage

43. A method for measuring characteristics in an optical system, comprising the steps of:
receiving a modulated source signal having unknown wavelength characteristics from a source under test;
providing the modulated source signal to a reference system having known time delay characteristics as a function of wavelength to generate a second signal; and
receiving a modulation signal; measuring delay between a transition of the second signal and a transition of the modulation signal to determine system characteristics.

44. The method of claim 43 wherein the system characteristics comprise source under test wavelength characteristics.

45. The method of claim 43 wherein the system characteristics comprise reference system time jitter characteristics.

46. The method of claim 43 wherein the system characteristics comprise source under test jitter characteristics.

47. The method of claim 43, further comprising the step of measuring jitter between the second signal and the modulation signal.

48. The method of claim 43, further comprising the step of:
measuring delay between a transition of the modulated source signal and a transition of the second signal to determine system characteristics.

49. The method of claim 43, further comprising the steps of:
measuring delay between a transition of the modulated source signal; and
a transition of the modulation signal to determine system characteristics.

50. The method of claim 43, further comprising the step of measuring delay between transitions of the modulated source signal.

51. The method of claim 43, further comprising the step of measuring delay between transitions of the second signal.

52. The method of claim 43, further comprising the step of measuring delay between transitions of the modulation signal.

53. The method of claim 44, wherein the wavelength characteristics are selected from a group comprising spectrum, jitter, drift, unit to unit variations, power supply variations, temperature, time, and chirp.

54. The method of claim 43, wherein the measuring step comprises the step of comparing transitions of the second signal and transitions of the modulation signal relative to a threshold voltage.

55. The method of claim 43, wherein the reference system known time delay characteristics are measured through the steps of:
receiving a modulated source signal having two or more known wavelengths;
splitting the signal into a first source and second source signal;
providing the second source signal to a system under test to generate a system under test signal; and
measuring delay between transitions of the first source signal and transitions of the system under test signal for two or more wavelengths to determine reference system characteristics.

56. The method of claim 43, wherein the reference system known time delay characteristics are measured through the steps of:
receiving a modulated source signal having two or more known wavelengths;
splitting the signal into a first source and second source signal;
providing the second source signal to a system under test to generate a system under test signal; and
measuring delay between transitions of the first source signal and transitions of the system under test signal for two or more wavelengths to determine reference system delay time characteristics as a function of wavelength.

57. The method of claim 44, wherein the reference system known time delay characteristics are measured through the steps of:
receiving a modulated source signal having two or more known wavelengths;
splitting the signal into a first source and second source signal; providing the second source signal to a system under test to generate a system under test signal; and
measuring delay between transitions of the first source signal and transitions of the system under test signal for two or more wavelengths to determine reference system jitter characteristics.

58. The method of claim 57, wherein the system delay time characteristics describe signal dispersion.

59. The method of claim 56, wherein the measuring step comprises the step of measuring delay between transitions of the first signal and the transitions of the third signal relative to a threshold voltage.

60. The method of claim 43, wherein the reference system known time delay characteristics are measured through the steps of:
receiving a modulated source signal having two or more known wavelengths;
providing the modulated source signal to a system under test to generate a system under test signal;
receiving a modulation signal; and
measuring delay between transitions of the modulation signal and transitions of the system under test signal for two or more wavelengths to determine reference system characteristics.

61. The method of claim 44, wherein the reference system known time delay characteristics are measured through the steps of:
receiving a modulated source signal having two or more known wavelengths;
providing the modulated source signal to a system under test to generate a system under test signal;
receiving a modulation signal; and
measuring delay between transitions of the modulation signal and transitions of the system under test signal for two or more wavelengths to determine reference system delay time characteristics as a function of wavelength.

62. The method of claim 45, wherein the reference system known time delay characteristics are measured through the steps of:
receiving a modulated source signal having two or more known wavelengths;
providing the modulated source signal to a system under test to generate a system under test signal;
receiving a modulation signal; and
measuring delay between transitions of the modulation signal and transitions of the system under test signal for two or more wavelengths to determine reference system jitter characteristics.

63. The method of claim 61, wherein the system delay time characteristics describe signal dispersion.

64. The method of claim 60, wherein the measuring step comprises the step of measuring delay between transitions of the first signal and transitions of the third signal relative to a threshold voltage.

65. An apparatus for measuring characteristics in an optical system having a modulated light source having unknown wavelength characteristics and a reference system having known time delay characteristics as a function of wavelength, comprising:
a splitter, coupled to the modulated light source, having a first output providing a first signal and a second output for providing a second signal;
the reference system coupled to the second output to generate a third signal; and
a time domain optical analyzer for measuring delay between a transition of the first signal and a transition of the third signal to determine system characteristics.

66. The apparatus of claim 65 wherein the system characteristics comprise modulated light source wavelength characteristics.

67. The apparatus of claim 65 wherein the system characteristics comprise reference system time jitter characteristics.

68. The apparatus of claim 65 wherein the system characteristics comprise source under test jitter characteristics.

69. The apparatus of claim 65, further comprising the step of measuring jitter between the first signal and the third signal.

70. The apparatus of claim 65, further comprising the steps of:
receiving a modulation signal; and
measuring delay between the transition of the first signal and the transition of the modulation signal to determine system characteristics

71. The apparatus of claim 65, further comprising the steps of:
receiving a modulation signal; and
measuring delay between the transition of the third signal and the transition of the modulation signal to determine system characteristics.

72. The apparatus of claim 65, wherein the optical analyzer measures delay between a transitions of the first signal.

73. The apparatus of claim 65, wherein the optical analyzer measures delay between transitions of the third signal.

74. The apparatus of claim 70, further comprising a modulation signal, wherein the optical analyzer measures delay between transitions of the modulation signal.

75. The apparatus of claim 66, wherein the light source wavelength characteristics are selected from a group comprising spectrum, jitter, drift, unit to unit variations, power supply variations, temperature, time, and chirp.

76. The apparatus of claim 65, wherein the time domain optical analyzer comprises voltage comparators which receive the second signal and the third signal.

77. The apparatus of claim 65, the reference system comprising:
a modulated light source having two or more known wavelengths;
a splitter, coupled to the modulated light source, having a first output providing a first source signal and a second output providing a second source signal;
a system under test coupled to the first output to generate a test signal; and
a time domain optical analyzer for measuring delay between transitions of the test signal and transitions of the first source signal for two or more wavelengths to determine reference system time characteristics.

78. The apparatus of claim 65, the reference system comprising:
a modulated light source having two or more known wavelengths;
a splitter, coupled to the modulated light source, having a first output providing a first source signal and a second output providing a second source signal;
a system under test coupled to the first output to generate a test signal; and
a time domain optical analyzer for measuring delay between transitions of the test signal and transitions of the first source signal for two or more wavelengths to determine reference system delay time characteristics as a function of wavelength.

79. The apparatus of claim 65, the reference system comprising:
a modulated light source having two or more known wavelengths;
a splitter, coupled to the modulated light source, having a first output providing a first source signal and a second output providing a second source signal;
a system under test coupled to the first output to generate a test signal; and
a time domain optical analyzer for measuring delay between transitions of the test signal and transitions of the first source signal for two or more wavelengths to determine reference system jitter characteristics.

80. The apparatus of claim 78, wherein the system delay time characteristics describe signal dispersion.

81. The apparatus of claim 77, wherein the time domain optical analyzer comprises voltage comparators which receive the test signal and the first source signal.

82. The apparatus of claim 65, the reference system comprising:
a modulator for generating a modulation signal;
a modulated light source having two or more known wavelengths;
a system under test coupled to the modulated light source to generate a test signal; and
a time domain optical analyzer for measuring delay between transitions of the test signal and transitions of the modulation signal for two or more wavelengths to determine reference system time characteristics.

83. The apparatus of claim 65, the reference system comprising:
a modulator for generating a modulation signal; a modulated light source having two or more known wavelengths;
a system under test coupled to the modulated light source to generate a test signal; and
a time domain optical analyzer for measuring delay between transitions of the test signal and transitions of the modulation signal for two or more wavelengths for two or more wavelengths to determine reference system delay time characteristics as a function of wavelength.

84. The apparatus of claim 65, the reference system comprising:
a modulator for generating a modulation signal;
a modulated light source having two or more known wavelengths;
a system under test coupled to the modulated light source to generate a test signal; and
a time domain optical analyzer for measuring delay between transitions of the test signal and transitions of the modulation signal for two or more wavelengths for two or more wavelengths to determine reference system jitter characteristics.

85. The apparatus of claim 78, wherein the system delay time characteristics describe signal dispersion.

86. The apparatus of claim 77, wherein the time domain optical analyzer comprises voltage comparators which receive the test signal and the first source signal.

87. An apparatus for measuring characteristics in an optical system, comprising:
a modulator for generating a modulation signal;
a modulated light source, coupled to the modulator, having unknown wavelength characteristics;
a reference system having known time delay characteristics as a function of wavelength coupled to the modulated light source to generate a second signal; and
a time domain optical analyzer for measuring delay between a transition of the modulation signal and a transition of the second signal to determine system characteristics.

88. The apparatus of claim 87 wherein the system characteristics comprise modulated light source wavelength characteristics.

89. The apparatus of claim 87 wherein the system characteristics comprise reference system time jitter characteristics.

90. The apparatus of claim 87 wherein the system characteristics comprise source under test jitter characteristics.

91. The apparatus of claim 87, wherein the optical analyzer measures jitter between the second signal and the modulation signal.

92. The apparatus of claim 87, wherein the optical analyzer measures delay between transitions of the modulation signal and modulated light source.

93. The apparatus of claim 87, wherein the optical analyzer measures delay between transitions of the second signal and modulated light source.

94. The apparatus of claim 88, wherein the optical analyzer measures delay between transitions of the second signal.

95. The apparatus of claim 88, wherein the optical analyzer measures delay between transitions of the light source.

96. The apparatus of claim 88, wherein the optical analyzer measures delay between a transitions of the modulation signal.

97. The apparatus of claim 87, wherein the light source wavelength characteristics are selected from a group comprising spectrum, jitter, drift, unit to unit variations, power supply variations, temperature, time, and chirp.

98. The apparatus of claim 88, wherein the time domain optical analyzer comprises voltage comparators which receive the modulation signal and the second signal.

99. The apparatus of claim 87, the reference system comprising:
a modulated light source having two or more known wavelengths;
a splitter, coupled to the modulated light source, having a first output providing a first source signal and a second output providing a second source signal;
a system under test coupled to the first output to generate a test signal; and
a time domain optical analyzer for measuring delay between a transition of the test signal and a transition of the first source signal for two or more wavelengths to determine reference system time characteristics.

100. The apparatus of claim 87, the reference system comprising:
a modulated light source having two or more known wavelengths;
a splitter, coupled to the modulated light source, having a first output providing a first source signal and a second output providing a second source signal;
a system under test coupled to the first output to generate a test signal; and
a time domain optical analyzer for measuring delay between the transition of the test signal and the transition of the first source signal for two or more wavelengths to determine reference system delay time characteristics as a function of wavelength.

101. The apparatus of claim 87, the reference system comprising:
a modulated light source having two or more known wavelengths;
a splitter, coupled to the modulated light source, having a first output providing a first source signal and a second output providing a second source signal;
a system under test coupled to the first output to generate a test signal; and
a time domain optical analyzer for measuring delay between the transition of the test signal and the transition of the first source signal for two or more wavelengths to determine reference system jitter characteristics.

102. The apparatus of claim 88, wherein the system delay time characteristics describe signal dispersion.

103. The apparatus of claim 87, wherein the time domain optical analyzer comprises voltage comparators which receive the test signal and the first source signal.

104. The apparatus of claim 87, the reference system comprising:
a modulator for generating a modulation signal; a modulated light source having two or more known wavelengths;
a system under test coupled to the modulated light source to generate a test signal; and
a time domain optical analyzer for measuring delay between a transition of the test signal and a transition of the modulation signal for two or more wavelengths to determine reference system time characteristics.

105. The apparatus of claim 87, the reference system comprising:
a modulator for generating a modulation signal;
a modulated light source having two or more known wavelengths;
a system under test coupled to the modulated light source to generate a test signal; and
a time domain optical analyzer for measuring delay between a transition of the test signal and a transition of the modulation signal for two or more wavelengths for two or more wavelengths to determine reference system delay time characteristics as a function of wavelength.

106. The apparatus of claim 87, the reference system comprising:
a modulator for generating a modulation signal;
a modulated light source having two or more known wavelengths;
a system under test coupled to the modulated light source to generate a test signal; and
a time domain optical analyzer for measuring delay between a transition of the test signal and a transition of the modulation signal for two or more wavelengths for two or more wavelengths to determine reference system jitter characteristics.

107. The apparatus of claim 105, wherein the system delay time characteristics describe signal dispersion.

108. The apparatus of claim 87, wherein the time domain optical analyzer comprises voltage comparators which receive the test signal and the first source signal.
